(19) United States
(12) Patent Application Publication
(10) Pub. No.: US 2016/0185163 A1
(43) Pub. Date: Jun. 30, 2016

(54) TIRE HAVING A PARTICULAR GRAPHIC ELEMENT

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Olivier MUHLHOFF, Clermont-Ferrand (FR); Eric BERGER, Clermont-Ferrand (FR); Benoit GARDARIN, Clermont-Ferrand (FR); Bruno GUIMARD, Clermont-Ferrand (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 14/910,229

(22) PCT Filed: Aug. 1, 2014
(86) PCT No.: PCT/EP2014/066644

§ 371 Date: Feb. 4, 2016

(30) Foreign Application Priority Data
Aug. 7, 2013 (FR) 1357850

(51) Int. Cl. B60C 13/02; B60C 13/00

(52) U.S. Cl. CPC B60C 13/02; B60C 13/001

(57) ABSTRACT

The aspects disclosed herein relate to a tire composing elastomeric properties. The tire includes a sidewall and a texture. The texture may include a plurality of strands distributed in a graphic element at a density at most of five strands per square millimeter (mm²), each strand having a mean cross section of between 0.0007 mm² and 0.06 mm². The texture includes a plurality of substantially mutually parallel lamellae, the spacing of the lamellae being at most 0.5 mm, with, each lamella having a mean width of between 0.03 mm and 0.3 mm. The texture is recessed into the sidewall with the texture defining the graphic element.

This application is a 371 national phase entry of PCT/EP2014/066644, filed 1 Aug. 2014, which claims the benefit of French Patent Application No. 1357850, filed 7 Aug. 2013, the contents of which are incorporated herein by reference for all purposes.

### BACKGROUND

The present disclosure relates to a tire for a motor vehicle including a particular graphic element.

### DESCRIPTION OF RELATED ART

Tire sidewalls have a great many markings intended to provide technical and legal information or to allow consumers to discern the origin of the product.

Attempts are constantly being made at improving the visibility and legibility of these markings on tire sidewalls.

Document US 2008/0283169 describes a tire made of rubbery material comprising a sidewall and a marking formed on this sidewall. The marking is positioned in a housing recessed into the sidewall. This marking protrudes from the bottom of the housing so that it enjoys good visibility on the tire sidewall.

However, during running, large amounts of mud or dust may become lodged in the housing, thereby reducing the contrast between the marking and the bottom of the housing.

### SUMMARY

An aspect of the invention relates to a tire composing elastomeric properties including a sidewall and a texture having a plurality of strands distributed in a graphic element at a density at least equal to five strands per square millimeter (mm²), each strand having a mean cross section of between 0.0007 mm² and 0.06 mm² and/or the texture having a plurality of substantially mutually parallel lamellae, the spacing of the lamellae being at most equal to 0.5 mm, with each lamella having a mean width of between 0.03 mm and 0.3 mm. The texture is recessed into the sidewall, this texture defining a graphic element.

The texture, arranged in the graphic element and formed by strands or lamellae, affords numerous advantages. On the one hand, this texture allows all or some of the incident rays of light that encounter the graphic element to become “trapped”. This makes it possible to give this graphic element a darker appearance thereby improving its contrast and therefore its visibility against the rest of the sidewall. On the other hand, this particular texture makes it possible to obtain a pleasant “velour”-like feel in the region of the graphic element. In addition, the texture used has hydrophobic properties which means that it is easier for water, dust or mud to drain from the graphic element. Furthermore, the graphic element is more durable. This is because the texture is recessed into the sidewall, and thus, texture is protected by the sidewall against certain types of wear, for example wear caused by curbing.

In one alternative form of the embodiment, the graphic element is selected from a group of graphic elements comprising at least: letters, numbers, symbols.

In another alternative form of the embodiment, the strands of the graphic element or, respectively, the lamellae of the graphic element, end lie flush with the sidewall of the tire.

In this way, these strands or, respectively, these lamellae, extend the external surface of the sidewall of the tire. The overall visual impression of this sidewall is thus improved.

In another alternative form of the embodiment, the strands of the graphic element or, respectively, the lamellae of the graphic element are set back in relation to the sidewall of the tire.

The sidewall of the tire thus protects the texture of strands and/or lamellae from mechanical attack that this sidewall may suffer. This then improves the durability of the texture.

In another alternative form of embodiment, the strands of the graphic element or, respectively, the lamellae of the graphic element protrude beyond the sidewall of the tire.

The emerging parts of the strands or, respectively, of the lamellae, have a certain flexibility because of their slenderness. When the texture experiences rubbing, these strands or, respectively, these lamellae, deform, thereby absorbing some of the force of this rubbing. In this way, the graphic element is protected against wear and becomes more durable. Furthermore, the fact that the strands or, respectively, the lamellae, of the texture protrude beyond the sidewall of the tire affords an overall improvement to the tactile effect of the texture.

In one preferred embodiment, part of the strands of the graphic element or, respectively, part of the lamellae of the graphic element protrude beyond the sidewall of the tire and another part of these strands or, respectively, of these lamellae are set back in relation to this sidewall.

This makes it possible to strike a good balance between protecting the texture on the one hand and protecting the graphic element on the other.

### BRIEF DESCRIPTION OF THE DRAWINGS

Further features and advantages of embodiments of the invention will become apparent from the following description, given by way of non-limiting example, with reference to the attached drawings in which:

FIG. 1 is a schematic perspective view of a tire sidewall and of a graphic element present on this sidewall;

FIG. 2 is a view in section on X-X′ of FIG. 1, of a graphic element according to a first embodiment of the invention;

FIG. 3 is a view in section on X-X′ of FIG. 1, of a graphic element according to a second embodiment of the invention;

FIG. 4 is a view in section on X-X′ of FIG. 1 of a graphic element according to a third embodiment of the invention;

FIG. 5 depicts the condition of the texture present in the graphic element of FIG. 4 when the sidewall experiences mechanical forces;

FIG. 6 is a view in section on X-X′ of FIG. 1 of a graphic element according to a fourth embodiment of the invention;

FIG. 7 is a schematic view of a texture present in the graphic element of FIG. 1 and comprising strands;

FIG. 8 is a schematic view of a texture present in the graphic element of FIG. 1 and comprising lamellae.

### DETAILED DESCRIPTION

In the description which will follow, elements that are substantially identical or similar will be denoted by identical references.

A solution that allows high-contrast marking to be preserved on the sidewall of a tire as this tire runs is disclosed herein.

A “tire” is defined as any type of resilient tire, whether or not subjected to an internal pressure.

The “tread” of a tire is defined as a quantity of rubbery material delimited by lateral surfaces and by two main surfaces, one of which is intended to come into contact with a roadway when the tire is running.

The “sidewall” of a tire is defined as a lateral surface of the tire positioned between the tire tread and a head of this tire.

A “graphic element” on a sidewall is defined as all or part of a marking present on this sidewall.

A “strand” is defined as a filiform element of which the height is at least equal to twice the diameter of a disc having the same surface area as a mean cross section of this strand.

The “mean cross section” of a strand is defined as the mean of the cross sections measured at regular intervals from the base of the strand to the tip of this strand.

A “lamella” is defined as elongated strands that have a length at least equal to twice their height.

The “mean width” of a lamella is defined the mean of the widths measured at regular intervals from the base of the lamella to the tip of this lamella.

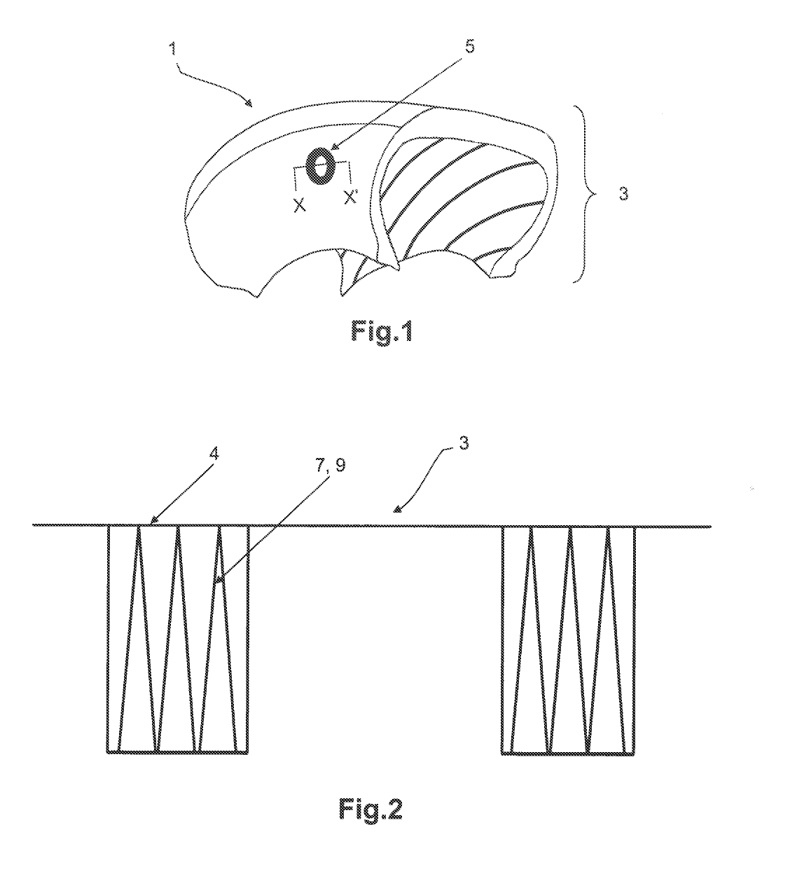

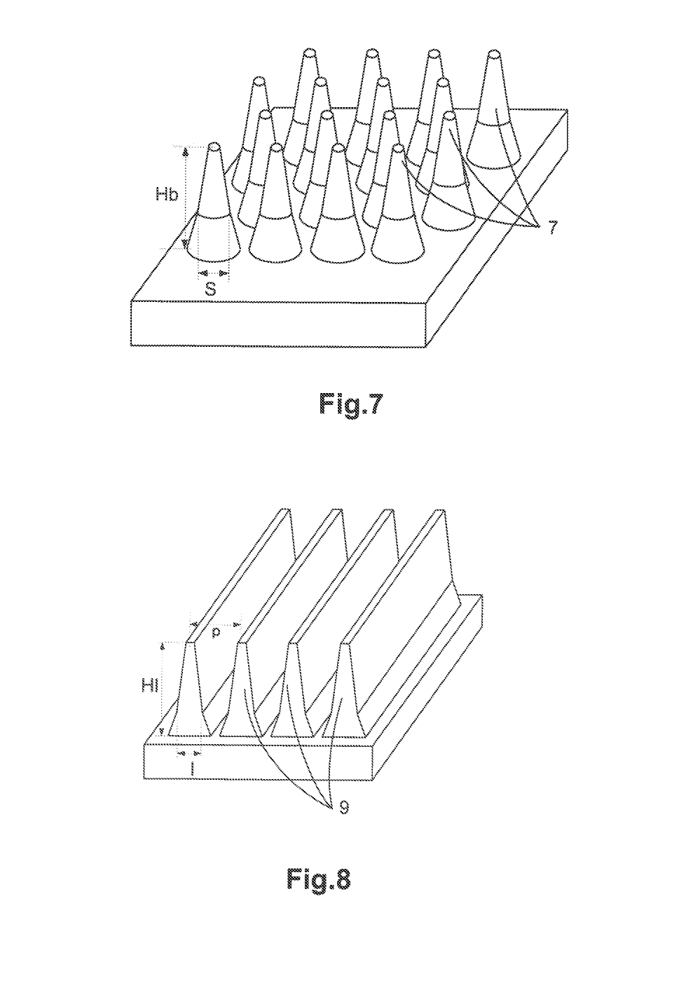

FIG. 1 depicts a sidewall 3 of a tire 1. This tire sidewall has a graphic element 5. The graphic element 5 in this instance is entirely filled with a texture. This texture comprises a plurality of strands 7, as depicted in FIG. 7. In this figure, the strands 7 have a conical overall shape with a cross section that reduces along the height Hb of these strands. More specifically, the mean cross section of each strand, corresponding to the mean of the cross sections S measured at regular intervals from the base of the strand, is between 0.0007 mm² and 0.06 mm². In the texture, the strands are distributed with a density at least equal to five strands per square millimeter (mm).

Alternatively, the texture includes a plurality of lamellae 9, as depicted in FIG. 8. In this figure, the lamellae 9 have a triangular overall cross section and the mean width of each lamellae, corresponding to the mean of the widths 1 measured at regular intervals along the height H1 of the lamella, is between 0.03 mm and 0.3 mm. In the texture, the lamellae 9 are substantially mutually parallel and the spacing P of the lamellae is at most equal to 0.5 mm.

Alternatively, the texture includes a combination of strands 7 and of lamellae 9.

FIG. 2 depicts a view in cross section of the texture present in the graphic element 5 according to a first embodiment of the invention. This texture comprises strands 7 and/or lamellae 9.

More specifically, the strands 7 of the texture or, respectively, the lamellae 9 of the texture, here end flush with the sidewall 3 of the tire, and thus, the tips of these strands 7 or, respectively, the tips of these lamellae 9, lie at the same level as the upper surface 4 of the sidewall 3.

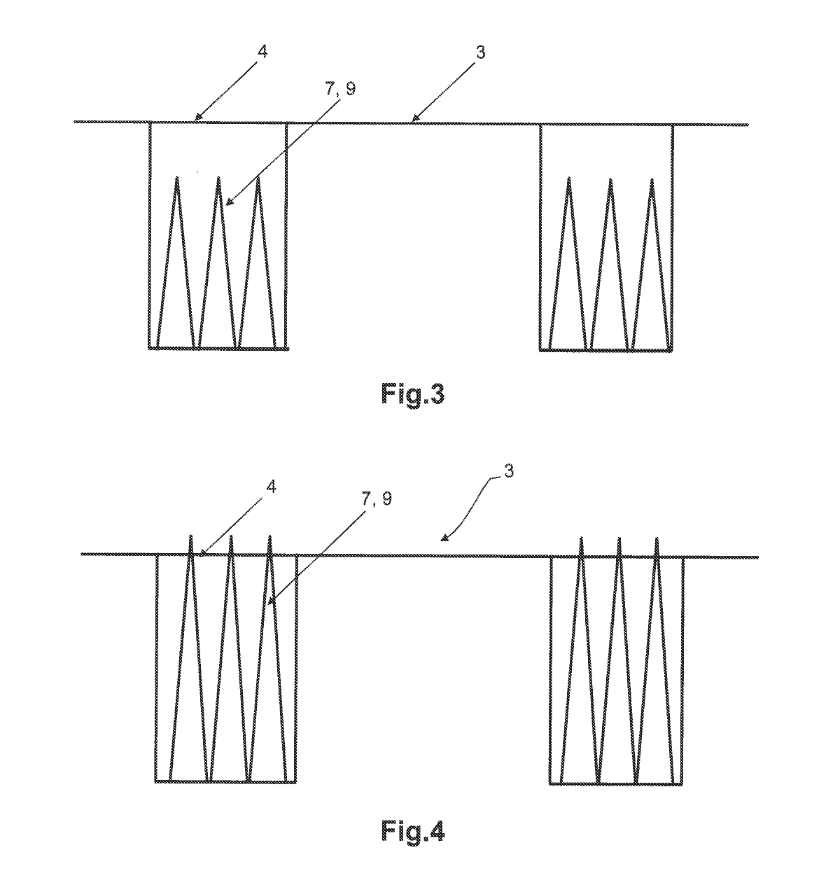

Alternatively, as shown in FIG. 3, the strands 7 of the texture or, respectively, the lamellae 9 of the texture, are set back in relation to the sidewall 3, and thus, the tips of these strands 7 or, respectively, the tips of these lamellae 11 are below the upper surface 4 of the sidewall 3.

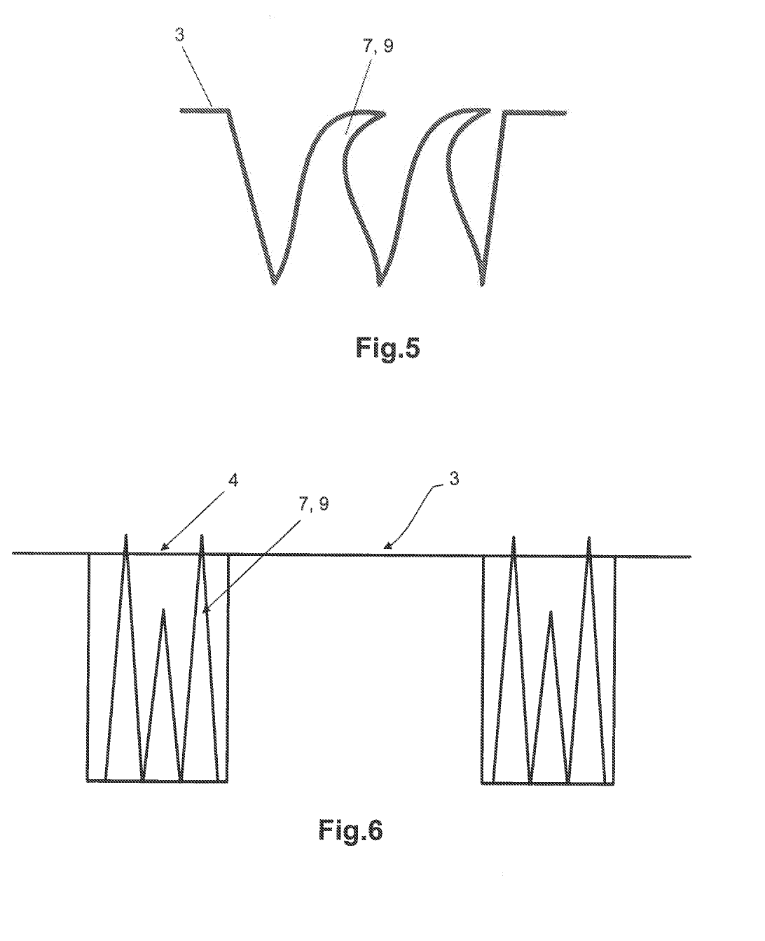

Alternatively, as shown in FIG. 4, the strands 7 of the texture or, respectively, the lamellae 9 of the texture, protrude beyond the sidewall 3 of the tire, and thus, the tips of these strands 7 or, respectively, the tips of these lamellae 9, protrude beyond the upper surface 4 of the sidewall 3. If the sidewall of the tire is rubbed in the region of the graphic element, the strands 7 or, respectively, the lamellae 9, flex, as can be seen in FIG. 5, absorb all or some of the force of this rubbing.

Alternatively, as shown in FIG. 6, part of the strands 7 of the texture or, respectively, part of the lamellae 9 of the texture, protrude beyond the upper surface 4 of the sidewall 3 of the tire and another part of these strands 7 or, respectively, of these lamellae 9, are set back in the graphic element. For preference, at least 50% of the strands 7 or, respectively, of the lamellae 9, protrude beyond the upper surface 4 of the sidewall 3.

The aspects disclosed above are not restricted to the examples described and depicted and various modifications can be made thereto without departing, from its scope.

The sidewall of the tire may bear other graphic elements which do not have a texture as described Herein.

Finally, the lamellae 9 of FIG. 8 may be discontinuous. They may further have differences in cross section from one another.

1. A tire, the tire composing elastomeric properties, comprising:
a sidewall;
a texture including a plurality of strands distributed in a graphic element at a density at least equal to five strands per square millimeter (mm²), each of the plurality of strands having a mean cross section of between 0.0007 mm² and 0.06 mm², and/or
the texture including a plurality of lamellae, the plurality of lamellae being substantially parallel with each other, the spacing of the lamellae being equal or less than 0.5 mm, each of the plurality of lamellae having a mean width of between 0.03 mm and 0.3 mm,
wherein the texture is recessed into the sidewall, the texture defining a graphic element.

2. The tire according to claim 1, wherein the graphic element is selected from a group of graphic elements comprising at least:
letters;
numbers; and
symbols.

3. The tire according to claim 1, wherein the plurality of strands or, the lamellae, are flush with the sidewall of the tire.

4. The tire according to claim 1, in wherein the plurality of strands or the lamellae are set back in relation to the sidewall of the tire.

5. The tire according to claim 1, wherein the plurality of strands of the graphic element or the lamellae protrude beyond the sidewall of the tire.

6. The tire according to claim 1, wherein the strands or part of the lamellae protrude beyond the sidewall of the tire and another part of the plurality of strands, the lamellae are set back in relation to the sidewall.
